(19) United States
(12) Patent Application Publication
(10) Pub. No.: US 2018/0365687 A1
(43) Pub. Date: Dec. 20, 2018

(54) FRAUD DETECTION

(71) Applicant: EMC IP Holding Company LLC, Hopkinton, MA (US)

(72) Inventors: Lior Asher, Tel Aviv (IL); Yedidya Dotan, Newton, MA (US); Ido Zilberberg, Netanya (IL)

(21) Appl. No.: 16/115,183

(22) Filed: Aug. 28, 2018

Related U.S. Application Data
(63) Continuation of application No. 13/931,959, filed on Jun. 30, 2013.

(51) Int. Cl. G06Q 20/38

(52) U.S. Cl. CPC G06Q 20/382

(57) ABSTRACT

There is disclosed a technique for use in fraud detection. In one embodiment, the technique comprises identifying an amendment to user contactable information associated with a user profile which belongs to a user with access to a protected resource. The technique also comprises obtaining the amended user contactable information associated with the user profile. The technique further comprises providing the amended user contactable information associated with the user profile for use in processing an electronic transaction.

### TECHNICAL FIELD

The field relates generally to information technology, and more particularly to fraud detection.

### BACKGROUND OF THE INVENTION

A reputation system computes reputation scores for a set of objects (e.g. service providers, services, goods or entities) within a community or domain based on a collection of opinions that other entities hold about the objects. The opinions are typically passed as ratings to a reputation center which uses a specific reputation algorithm to dynamically compute the reputation scores based on the received ratings.

Since the collective opinion in a community determines an object's reputation score, reputation systems represent a form of collaborative sanctioning. A low score represents a collaborative sanctioning of an object that the community perceives as having or providing low quality. Similarly, a high score represents a collaborative praising of an object that the community perceives as having or providing high quality. Reputation scores change dynamically as a function of incoming ratings. A high score can quickly be lost if rating entities start providing negative ratings. Similarly, it is possible for an object with a low score to recover and regain a high score.

Traditionally, the above type of reputation systems have been more associated with the retail sector and the like in which an entity in a community uses reputation scores for decision making (e.g. whether or not to buy a specific service or good). However, the systems are also now very much in demand in the security sector. For example, the electronic fraud network (EFN), as provided by RSA, The Security Division of EMC, includes collaborative cross-institution online networks dedicated to sharing and disseminating information to help facilitate and maintain security for its customers. EFN customers commonly share information on fraudulent activities, whereby data elements that are found to participate in potentially fraudulent transactions (as well as data elements found to participate in genuine non-fraudulent activities) are passed to a central engine for processing. Routinely, in existing EFN-based fraud detection approaches, such identified data elements are also assigned a risk score which determines the likelihood that a given data element (for example, an internet protocol (IP) address) will be a source of additional fraud in the future.

However, a challenge facing the above systems in the security sector is that fraudsters are getting more sophisticated and intelligent. One simple example, a fraudster can commit a fraud from an IP address which a customer shares with the EFN to enable the EFN in turn to share with other customers. The above sharing of information is useful provided the frauster commits another fraud from the same IP address in the future. If a fraud is not commited from this IP address then the chances of catching the fraud are somewhat reduced.

Although the above systems in the security sector are advanced, there is a need for more techniques that can assist in detecting fraud.

### SUMMARY OF THE INVENTION

There is disclosed a computer-implemented method for use in fraud detection, the method comprising: identifying an amendment to user contactable information associated with a user profile, wherein the user profile belongs to a user with access to a protected resource; obtaining the amended user contactable information associated with the user profile; and providing the amended user contactable information associated with the user profile for use in processing an electronic transaction.

There is also disclosed an electronic apparatus for use in fraud detection, the apparatus comprising: a network interface; memory; and control circuitry coupled to the network interface and memory, the memory storing instructions, which, when carried out by the control circuitry, cause the control circuitry to: identify an amendment to user contactable information associated with a user profile, wherein the user profile belongs to a user with access to a protected resource; obtain the amended user contactable information associated with the user profile; and provide the amended user contactable information associated with the user profile for use in processing an electronic transaction.

There is further disclosed a computer program product having a non-transitory computer readable storage medium which stores a set of instructions for use in fraud detection, the set of instructions, when carried out by computerized circuitry, causing the computerized circuitry to perform a method of: identifying an amendment to user contactable information associated with a user profile, wherein the user profile belongs to a user with access to a protected resource; obtaining the amended user contactable information associated with the user profile; and providing the amended user contactable information associated with the user profile for use in processing an electronic transaction.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a diagram illustrating an example network environment in which one or more embodiments of the present invention can operate;

FIG. 2 is a block diagram illustrating example system components, according to an embodiment of the invention;

FIG. 3 is a flow diagram illustrating techniques according to an embodiment of the invention;

FIG. 4 shows an exemplary embodiment of a communication system that may incorporate the functionality of the type illustrated in at least one embodiment of the invention; and

FIG. 5 is a system diagram of an exemplary computer system on which at least one embodiment of the invention can be implemented.

### DETAILED DESCRIPTION

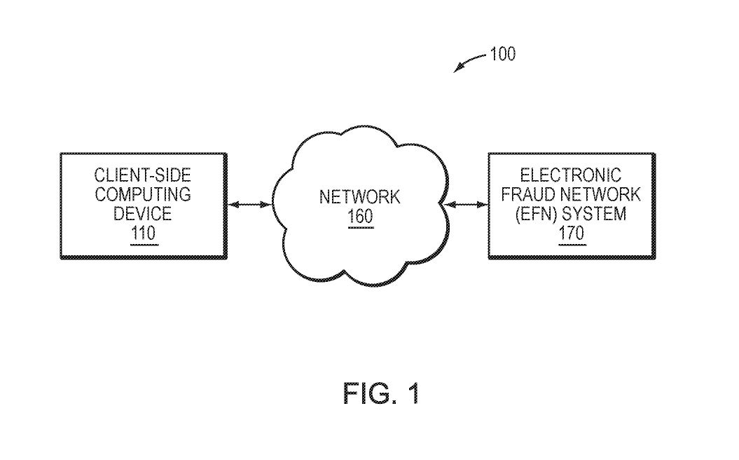

Referring to FIG. 1, there is illustrated an example network environment 100 in which one or more embodiments of the present invention can operate. In this embodiment, the network environment 100 comprises a client-side computing device (CSCD) 110 communicating with a reputation system 170 over a network 160. In this particular case, the reputation system is an electronic fraud network (EFN) system 170 as provided by RSA, The Security Division of EMC. The network 160 can include, for example, a global computer network such as the Internet, a wide area network (WAN), a local area network (LAN), a satellite network, a telephone or cable network, or various portions or combinations of these and other types of networks.

In at least one embodiment of the invention, the CSCD 110 is a customer server which updates the EFN system 170 (or, for example, an EFN agent) with data. Such an embodiment can be implemented within the context of a business-to-business (B2B) application. Also, in other embodiments, the CSCD 110 may represent a portable device, such as a mobile telephone, personal digital assistant (PDA), wireless email device, etc. The CSCD 110 may alternatively represent a desktop or laptop personal computer (PC), a microcomputer, a workstation, a mainframe computer, or any other information processing device. It is to be appreciated that a given embodiment may include multiple instances of CSCD 110 and possibly other components, although only a single instance is shown in the simplified diagram of FIG. 1 for clarity of illustration.

The CSCD 110 may also be referred to herein as simply a “customer.” The term “customer,” as used in this context, should be understood to encompass, by way of example and without limitation, a customer device, a person or entity utilizing or otherwise associated with the device, or a combination of both. An operation described herein as being performed by a customer may therefore, for example, be performed by a customer device, a person or entity utilizing or otherwise associated with the device, or by a combination of both the person and the device. Similarly, information described as being associated with a customer may, for example, be associated with a CSCD device 110, a person or entity utilizing or otherwise associated with the device, or a combination of both the person and the device.

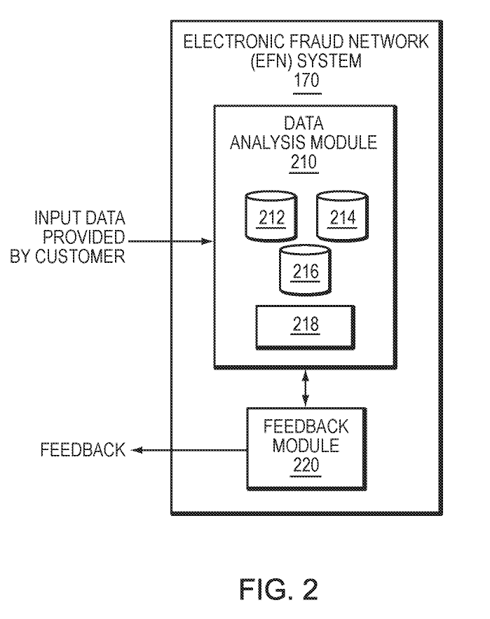

An exemplary EFN system (such as system 170 in FIG. 1) is described in additional detail below in connection with FIG. 2.

Referring to FIG. 2, there is illustrated example system components according to an embodiment of the invention. By way of illustration, the figure depicts the EFN system 170 receiving input data provided by a customer and outputting feedback. In this particular case, the input data relates to amended user contactable information of a user profile which belongs to a user with access to a protected resource on the customer side. Furthermore, in this particular case, the feedback relates to the risk associated with the amended user contactable information.

For example, a transaction is received at a bank from one of its online users subsequent to an amendement of an e-mail address in the user profile of the online user. The bank attempts to request approval from the genuine user to proceed with the transaction. However, the request for approval is sent to the amended e-mail address of the fraudster ultimately leading to approval by the fraudster and fraud. This amended e-mail information associated with the fraud is sent to the system 170 such that the system can assess the risk associated with other e-mail amendments that are received as input data and provide feedback.

In this particular embodiment, the EFN system 170 includes a data analysis module 210 and a feedback module 220. As described further herein, the data analysis module 210 can include multiple databases. For example, the module can include a first database 212, a second database 214 and a third database 216. Furthermore, the data analysis module 210 includes a risk score calculator module 218.

In this embodiment, the databases (212, 214, 216) contain information relating to user contactable information deemed associated with a fraudster and/or fraudulent activity. By way of example, the databases (212, 214, 216) include historical data, that is, information previously provided by and/or shared by a customer relating to e-mail addresses deemed to be associated with a fraudster and/or fraudulent activity. Due to privacy issues, the information in the databases is hashed such that any exposure of the data will only reveal an opaque string. It should be understood that the customers only have the hash function. In this particular embodiment, the database 212 contains the hashed name parts of amended e-mail addresses deemed to be associated with a fraudster and/or fraudulent activity. For example, the name part can be considered the part of the e-mail address before the ‘@’. Additionally, in this particular embodiment, the database 214 contains the hashed domain parts of amended e-mail addresses deemed to be associated with a fraudster and/or fraudulent activity. For example, the domain part can be considered the part of the e-mail address after the ‘@’. In some arrangements, the domain part can be divided into more than one part. For example, the domain name ‘company.com’ can be divided into two separate entries ‘company’ and the ‘.com’. Furthermore, in this particular embodiment, the database 216 contains the hashed amended e-mail addresses deemed to be associated with a fraudster and/or fraudulent activity. For example, the hashed amended e-mail address is the hashed entire e-mail address. It should be appreciated that the system 170 can continue to receive fraud/genuine markings from the customers with respect to the entries in the databases so that the number of incidents of fraud from the e-mail address (and its parts) can be recorded.

It should be understood that the databases (212, 214, 216) are populated by the customers 110 sending an indication of fraud to the EFN 170 together with the hashed name part, the hashed domain part and the hashed e-mail address. For example, the e-mail address johnsmith@company.com is deemed to be associated with a fraudster and/or fraudulent activity. The customer 110 sends information to the EFN 170 with an indication of known fraud, as follows:

hashed name part: johnsmith

hashed domain part: company.com

hashed e-mail address: johnsmith@company.com

In at least some embodiments, the data analysis module 210 is configured to receive input data with a request from a customer to assess an amended e-mail address for risk. For example, the input data containes a hashed name part, a hashed domain part and a hashed e-mail address. The data analysis module 210 is configured to compare the amended input data to historical fraudulent e-mail addresses in databases (212, 214, 216). The risk score calculator module 218 determines the risk based on the comparision. When determining a risk score, it should be understood that the information in the databases can have different rankings of importance. For example, the e-mail address in the database 216 is unique so if the input data contains a hashed e-mail address similar to one in the database then the risk will be high. It should be understood that if the input data contains johnsmith@company.com then the risk will be high as there is already an entry in database 216 with an indication of fraud as described above. On the other hand, if the input data contains a domain name with similar data to that in the database 214 the risk will not be as great unless the database 214 has several recordings of fraud from this domain. Again, following the above description, if the input data contains company.com then the risk will not be as great unless there are several incidents of fraud from company.com. Once the risk is determined, the feedback module 220 provides feedback relating to the risk of the e-mail amendment being associated with a fraudser and/or fraudulent activity.

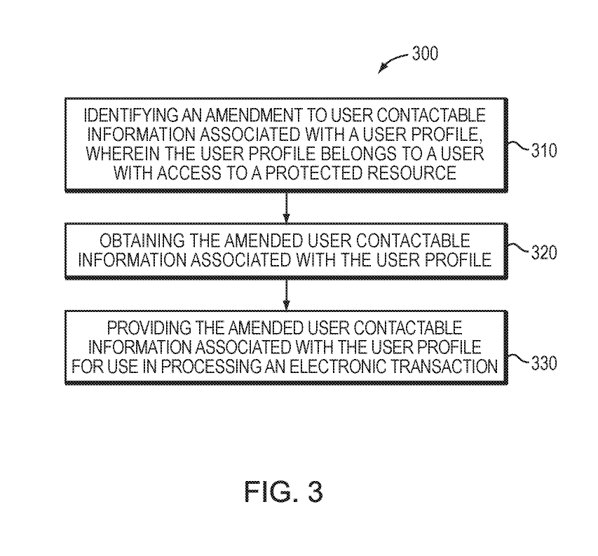

Referring to FIG. 3, there is illustrated a flow diagram illustrating a technique 300 according to an embodiment of the present invention. In the flow diagram, the operations are summarized in individual blocks. As will be described further below, the operations may be performed in hardware, or as processor-executable instructions that may be executed by a processor.

At step 310, the technique includes identifying an amendment to user contactable information associated with a user profile which belongs to a user with access to a protected resource. As described above, the step of identifying the amendment to user contactable information comprises receiving a communication from a customer in response to an amendment of user contactable information (i.e., e-mail address) at the customer side. It is to be understood that access to the protected resource is controlled at the customer side.

At step 320, the technique includes obtaining the amended user contactable information associated with the user profile. It should be understood from the foregoing description that the EFN obtains the amended e-mail address in a communication from the customer. In this particular embodiment, the obtained amended e-mail address is at least partly obfuscated. For example, the e-mail address is at least partly obfuscated as a result of hashing the e-mail address for security purposes. It is to be understood that the hashing occurs at the customer side.

At step 330, the technique comprises providing the amended user contactable information associated with the user profile for use in processing an electronic transaction. In this embodiment, the amended user contactable information as provided comprises at least two distinct parts for use in processing an electronic transaction. The above description with respect to FIG. 2 describes johnsmith@company.com which contains three distinct parts. For example, the hashed name part, the hashed domain part, the hashed e-mail address. In this particular embodiment, the step of providing the amended user contactable information comprises determining that the amended user contactable information is associated with fraud and providing the amended user contactable information for use in processing an electronic transaction based on determining that the amended user contactable is associated with fraud.

Advantageously, the technique enables detection of fraudulent transactions that are preceded with a change to contactable information associated with a user profile. For example, the change in e-mail address can result in a communication to a genuine user warning of suspicious activity being actually forwarded to an incorrect address associated with the fraudster. In this way, the genuine user may not be aware of the fraudulent activity as the fraudster is approving the activity through the amended e-mail address. The technique described herein provides advance notice of potentially fraudulent activity by determining an amendment to an e-mail address as being risky.

While the above description describes the user contactable information as an e-mail address, it should be apparent that the e-mail can be any information enabling instant communication with the user. For example, the information can enable communication with the user over a network such as an e-mail address, internet-based account, etc.

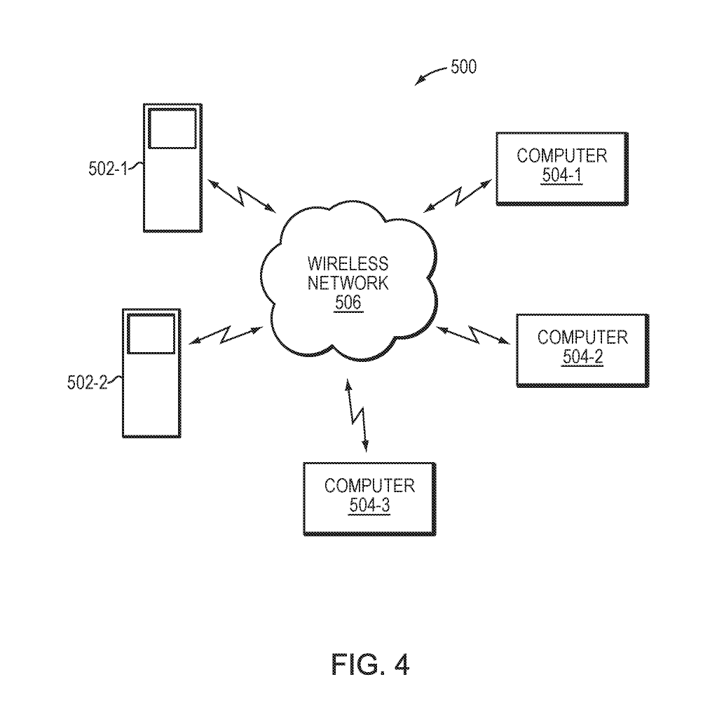

One exemplary communication system application that may incorporate such techniques will now be described with reference to FIG. 4. As depicted in FIG. 4, a communication system 500 comprises a plurality of mobile telephones 502-1 and 502-2 and computers 504-1, 504-2 and 504-3, configured to communicate with one another over a network 506. Any two or more of the devices 502 and 504 may correspond to cryptographic devices configured to implement at least one embodiment of the invention, as previously described. It is to be appreciated that the techniques disclosed herein can be implemented in numerous other applications.

Aspects of the present invention are described herein with reference to flowchart illustrations and/or block diagrams of methods, apparatus (systems) and computer program products according to embodiments of the invention. It is to be appreciated that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As further described herein, such computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, as further detailed below, at least one embodiment of the invention includes an article of manufacture tangibly embodying computer readable instructions which, when implemented, cause a computer to carry out techniques described herein.

The computer program instructions may also be loaded onto a computer or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s). It should be noted that the functions noted in the block may occur out of the order noted in the figures.

Accordingly, the techniques described herein can include providing a system, wherein the system includes distinct software modules, each being embodied on a tangible computer-readable recordable storage medium (for example, all modules embodied on the same medium, or each modules embodied on a different medium). The modules can run, for example, on a hardware processor, and the techniques detailed herein can be carried out using the distinct software modules of the system executing on a hardware processor.

Additionally, the techniques detailed herein can also be implemented via a computer program product that includes computer useable program code stored in a computer readable storage medium in a data processing system, wherein the computer useable program code was downloaded over a network from a remote data processing system. The computer program product can also include, for example, computer useable program code that is stored in a computer readable storage medium in a server data processing system, wherein the computer useable program code is downloaded over a network to a remote data processing system for use in a computer readable storage medium with the remote system.

As will be appreciated by one skilled in the art, aspects of the present invention may take the form of an entirely hardware embodiment, an entirely software embodiment (including firmware, resident software, micro-code, etc.) or an embodiment combining software and hardware aspects that may all generally be referred to herein as a “module” or “system.”

An aspect of the invention or elements thereof can be implemented in the form of an apparatus including a memory and at least one processor that is coupled to the memory and operative to perform the techniques detailed herein. Also, as described herein, aspects of the present invention may take the form of a computer program product embodied in a computer readable medium having computer readable program code embodied thereon.

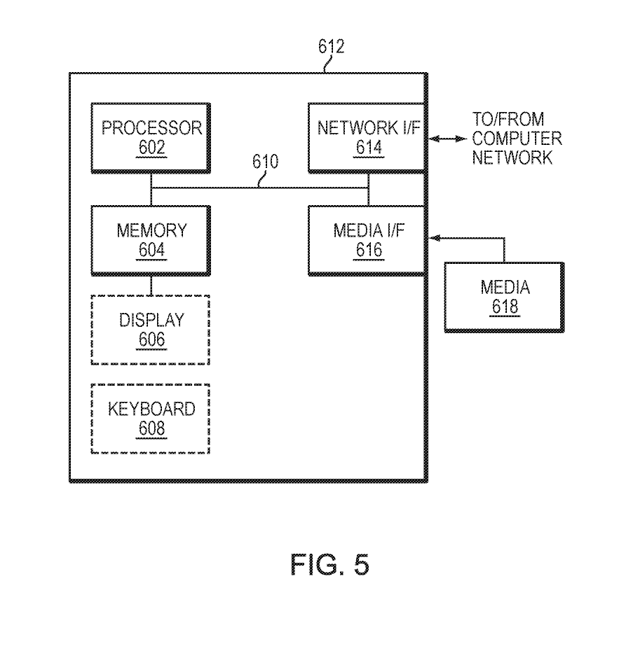

By way of example, an aspect of the present invention can make use of software running on a general purpose computer. As noted above, FIG. 5 is a system diagram of an exemplary computer system on which at least one embodiment of the invention can be implemented. As depicted in FIG. 5, an example implementation employs, for example, a processor 602, a memory 604, and an input/output interface formed, for example, by a display 606 and a keyboard 608. The term “processor” as used herein includes any processing device(s), such as, for example, one that includes a central processing unit (CPU) and/or other forms of processing circuitry. The term “memory” includes memory associated with a processor or CPU, such as, for example, random access memory (RAM), read only memory (ROM), a fixed memory device (for example, a hard drive), a removable memory device (for example, a diskette), a flash memory, etc. Further, the phrase “input/output interface,” as used herein, includes a mechanism for inputting data to the processing unit (for example, a mouse) and a mechanism for providing results associated with the processing unit (for example, a printer).

The processor 602, memory 604, and input/output interface such as display 606 and keyboard 608 can be interconnected, for example, via bus 610 as part of a data processing unit 612. Suitable interconnections via bus 610, can also be provided to a network interface 614 (such as a network card), which can be provided to interface with a computer network, and to a media interface 616 (such as a diskette or compact disc read-only memory (CD-ROM) drive), which can be provided to interface with media 618.

Accordingly, computer software including instructions or code for carrying out the techniques detailed herein can be stored in associated memory devices (for example, ROM, fixed or removable memory) and, when ready to be utilized, loaded in part or in whole (for example, into RAM) and implemented by a CPU. Such software can include firmware, resident software, microcode, etc.

As noted above, a data processing system suitable for storing and/or executing program code includes at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation. Also, input/output (I/O) devices such as keyboards 608, displays 606, and pointing devices, can be coupled to the system either directly (such as via bus 610) or through intervening I/O controllers.

Network adapters such as network interface 614 (for example, a modem, a cable modem or an Ethernet card) can also be coupled to the system to enable the data processing system to become coupled to other data processing systems or remote printers or storage devices through intervening private or public networks.

As used herein, a server includes a physical data processing system (such as system 612 as depicted in FIG. 5) running a server program. It will be understood that such a physical server may or may not include a display and keyboard.

As noted, at least one embodiment of the invention can take the form of a computer program product embodied in a computer readable medium having computer readable program code embodied thereon. As will be appreciated, any combination of computer readable media may be utilized. The computer readable medium can include a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. Examples include an electrical connection having one or more wires, a portable computer diskette, a hard disk, RAM, ROM, an erasable programmable read-only memory (EPROM), flash memory, an optical fiber, a portable CD-ROM, an optical storage device, a magnetic storage device, and/or any suitable combination of the foregoing. More generally, a computer readable storage medium may be any tangible medium that can contain, or store a program for use by or in connection with an instruction execution system, apparatus, or device.

Additionally, a computer readable signal medium may include a propagated data signal with computer readable program code embodied therein, for example, in baseband or as part of a carrier wave. Such a propagated signal may take any of a variety of forms such as, for example, electro-magnetic, optical, or a suitable combination thereof. More generally, a computer readable signal medium may be any computer readable medium that is not a computer readable storage medium and that can communicate, propagate, or transport a program for use by or in connection with an instruction execution system, apparatus, or device.

Program code embodied on a computer readable medium can be transmitted using an appropriate medium such as, for example, wireless, wireline, optical fiber cable, radio frequency (RF), and/or a suitable combination of the foregoing. Computer program code for carrying out operations in accordance with one or more embodiments of the invention can be written in any combination of at least one programming language, including an object oriented programming language, and conventional procedural programming languages. The program code may execute entirely on a user's computer, partly on a user's computer, as a stand-alone software package, partly on a users computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In light of the above descriptions, it should be understood that the components illustrated herein can be implemented in various forms of hardware, software, or combinations thereof, for example, application specific integrated circuit(s) (ASICS), functional circuitry, an appropriately programmed general purpose digital computer with associated memory, etc.

Terminology used herein is for the purpose of describing particular embodiments only and is not intended to be limiting of the invention. For example, the singular forms “a,” “an” and “the” are intended to include the plural forms as well, unless clearly indicated otherwise. It will be further understood that the terms “comprises” and/or “comprising,” as used herein, specify the presence of stated features, integers, steps, operations, elements, and/or components, but do not preclude the presence or addition of another feature, integer, step, operation, element, component, and/or group thereof. Additionally, the corresponding structures, materials, acts, and equivalents of all means or step plus function elements in the claims are intended to include any structure, material, or act for performing the function in combination with other claimed elements as specifically claimed.

Also, it should again be emphasized that the above-described embodiments of the invention are presented for purposes of illustration only. Many variations and other alternative embodiments may be used. For example, the techniques are applicable to a wide variety of other types of communication systems and cryptographic devices that can benefit from an automated data quality feedback loop. Accordingly, the particular illustrative configurations of system and device elements detailed herein can be varied in other embodiments. These and numerous other alternative embodiments within the scope of the appended claims will be readily apparent to those skilled in the art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A computer-implemented method for use in fraud detection, the method comprising:
collecting risk information provided by one or more sources, wherein the risk information comprises one or more email addresses amended by fraudsters to facilitate fraudulent activity;
receiving an electronic request from an additional source seeking to determine the riskiness of an amended email address;
in response to receiving the electronic request, performing an risk analysis of the risk information to determine how often respective username and domain parts of the amended email address have been used in fraudulent activity by fraudsters;
based on the analysis, determining a risk score indicating the likelihood that the amended email address has been amended by a fraudster to facilitate fraudulent activity; and
upon determining the risk score, sending an electronic communication to at least the additional source describing the riskiness of the amended email address such that remedial action can be taken if chosen by at least the additional source; and
wherein said collecting risk information, receiving an electronic request, performing an risk analysis, determining a risk score and sending an electronic communication are performed by at least one processing device comprising a processor coupled to a memory.

15. The computer-implemented method as claimed in claim 14, wherein the amended email address is at least partly obfuscated.

16. The computer-implemented method as claimed in claim 15, wherein the amended email address is at least partly obfuscated as a result of hashing at least a part of the amended email address.

17. The computer-implemented method as claimed in claim 14, wherein the amended email address is provided in at least two distinct parts.

18. The computer-implemented method as claimed in claim 17, wherein at least one of the parts is obfuscated.

19. An electronic apparatus for use in fraud detection, the apparatus comprising:
at least one processing device comprising a processor coupled to a memory; said at least one processing device being configured to:
collect risk information provided by one or more sources, wherein the risk information comprises one or more email addresses amended by fraudsters to facilitate fraudulent activity;
receive an electronic request from an additional source seeking to determine the riskiness of an amended email address;
in response to receiving the electronic request, perform an risk analysis of the risk information to determine how often respective username and domain parts of the amended email address have been used in fraudulent activity by fraudsters;
based on the analysis, determine a risk score indicating the likelihood that the amended email address has been amended by a fraudster to facilitate fraudulent activity; and
upon determining the risk score, send an electronic communication to at least the additional source describing the riskiness of the amended email address such that remedial action can be taken if chosen by at least the additional source.

20. A computer program product having a non-transitory computer readable storage medium which stores a set of instructions for use in fraud detection, the set of instructions, when carried out by at least one processing device, causing the at least one processing device to perform a method of:
collecting risk information provided by one or more sources, wherein the risk information comprises one or more email addresses amended by fraudsters to facilitate fraudulent activity;
receiving an electronic request from an additional source seeking to determine the riskiness of an amended email address;
in response to receiving the electronic request, performing an risk analysis of the risk information to determine how often respective username and domain parts of the amended email address have been used in fraudulent activity by fraudsters;
based on the analysis, determining a risk score indicating the likelihood that the amended email address has been amended by a fraudster to facilitate fraudulent activity; and
upon determining the risk score, sending an electronic communication to at least the additional source describing the riskiness of the amended email address such that remedial action can be taken if chosen by at least the additional source.
